(19) United States
(12) Patent Application Publication
(10) Pub. No.: US 2009/0135944 A1
(43) Pub. Date: May 28, 2009

(54) Cooperative-MIMO Communications

(76) Inventors: Justin S. Dyer, Stanford, CA (US); Balasubramaniam Natarajan, Manhattan, KS (US)

Correspondence Address: Steven J Shattil, PO Box 17355, Boulder, CO, 80308, US

(21) Appl. No.: 12/360,706

(22) Filed: Jan. 27, 2009

Related U.S. Application Data
(63) Continuation-in-part of application No. 11/585,061, filed on Oct. 23, 2006.

(51) Int. Cl. H04L 1/02

(52) U.S. Cl. 375/267; 714/792; 370/338

(57) ABSTRACT

Spatial subchannel codes for wireless devices operating in a cooperative antenna array are generated using an asymptotically optimal decoding algorithm, such as a trellis-exploration algorithm similar to the Viterbi algorithm. A trellis may be constructed using a number of desired subchannels, at least one code length, and a number of code-chip parameters. A fitness function is derived from a mathematical relationship between codes, and may include some measure of correlation of the codes. The selected codes correspond to paths having optimal path metrics derived from the fitness function. Multiple iterations through the trellis may be performed to refine a selection of the codes.

### BACKGROUND

1. Field of the Invention

The present invention relates generally to antenna-array processing, and more specifically to antenna-array processing between a plurality of wireless devices that employs a trellis-exploration algorithm for generating antenna-array weights.

2. Discussion of the Related Art

When wireless transceivers operate in an environment with many reflectors, received signals may arrive from different paths. This condition is known as multipath. Wireless transceivers may utilize multiple antennas to exploit multipath for increasing the communications bandwidth. For example, in some aspects, wireless transceivers may communicate using Multiple-Input, Multiple-Output (MIMO) techniques. In general, MIMO systems offer higher capacities by utilizing multiple spatial sub-channels made possible by multipath.

One particular application of MIMO-type technology is a cooperative antenna array, such as proposed in M. Dohler and H. Aghvami, “A step towards MIMO: Virtual Antenna Arrays,” European Cooperation in the field of Scientific and Technical Research, EURO-COST, Barcelona, Spain, Jan. 15-17, 2003, which is hereby incorporated by reference. Such MIMO techniques are also known as Cooperative MIMO, Virtual MIMO, Distributed MIMO, and Distributed Input Distributed Output (DIDO) techniques.

A cooperative antenna array comprises a group of wireless devices (such as cell phones) communicatively linked together by a wireless local area network (WLAN) if and when they are near enough to each other. The WLAN employs separate communication channels from the cellular channel to exchange information between the wireless devices so as to operate cooperatively. This allows single-antenna devices to potentially achieve MIMO-like increases in throughput by relaying information between several wireless devices in range of each other (in addition to being in range of the cellular base station) to operate as if they are physically one device with multiple antennas.

In practice, such systems are difficult to implement and have limited utility. Specifically, cooperative antenna arrays employ a second communication link (i.e., the WLAN), which is subject to uncertain availability. Lack of reliability can impede the ability of the system to benefit from distributing computational-processing tasks among the wireless devices. Furthermore, the wireless devices in a cooperating network are more expensive, physically larger, and consume more power because they have greater computational needs. For example, as the simultaneous channel utilization (e.g. transmissions utilizing MIMO) increases linearly, the computational burden of MIMO processing grows exponentially. Thus, prior-art cooperative-MIMO processing may very well be impractical for portable devices with tight power and size constraints.

MIMO systems may operate either in open-loop or closed-loop modes. In open-loop MIMO, a wireless transceiver estimates the state of the channel without receiving channel state information directly from another wireless transceiver. In general, open-loop systems employ exponential decoding complexity to estimate the channel. In closed-loop systems, communications bandwidth is utilized to transmit current channel state information between transceivers, thereby reducing the necessary decoding complexity, but also reducing overall throughput.

A transmitter may apply a pre-coding matrix P to a transmission signal, such as to provide for beamforming. The columns of a desired pre-coding matrix P may be viewed as transmit beamforming vectors because they give the direction of strong paths between the transmitter and a receiver. The resulting I/O model is expressed by

y=HPx+n,

where y is the received signal, x is the transmitted signal vector from the transmitter's antenna array, H denotes an N×N channel matrix, and n denotes additive white Gaussian noise with zero mean. If fewer than N spatial channels are to be used, the number of columns in P may be reduced by the number of unutilized spatial channels.

The pre-coding matrix P is typically selected to minimize or reduce cross correlation between different spatial sub-channels. Thus, pre-coding in a MIMO system embodies objectives and principles that may be similar to at least some of those related to multiple-access coding in Code Division Multiple Access (CDMA) systems, such as direct-sequence CDMA (DS-CDMA), multi-carrier CDMA, multi-code CDMA, spread-OFDM, and other types of CDMA systems.

In practice, decoding errors are minimized by using distinctive multiple-access codes with suitable autocorrelation and cross-correlation properties. The cross-correlation between any two code subspaces should be low for minimal interference. At the same time, it is desirable for the autocorrelation property of a multiple-access code to be steeply peaked, with small sidelobes. Maximally peaked code autocorrelation yields optimal acquisition and synchronization properties for communications. Unfortunately, favorable autocorrelation characteristics are typically achieved at the expense of cross-correlation characteristics, and vice versa.

Code selection typically involves a trade-off between autocorrelation and cross-correlation performance. Various code-design techniques are described in D. V. Sarwate, “Mean-square correlation of shift-register sequences,” Proc. IEEE, vol. 131(2), April 1984, pp. 795-799, K. Yang, et. al., “Quasi-orthogonal sequences for code-division multiple-access systems,” IEEE Trans. Inform. Theory, vol. 46, pp. 982-992, May 2003, in P. V. Kumar and O. Moreno, “Prime-phase sequences with periodic correlation properties better than binary sequences,” IEEE Trans. Inform. Theory, vol. 37, pp. 603-616, May 1991, and in I. Oppermann and B. S. Vucetic, “Complex spreading sequences with a wide range of correlation properties,” IEEE Trans. Commun., vol. 45, pp. 365-375, November 1997, which are hereby incorporated by reference.

Various code-selection techniques have been developed, including artificial-intelligence approaches to complex signature sequence estimation, such as described in E. Buehler, B. Natarajan, and S. Das, “Multiobjective genetic algorithm based complex spreading code sets with a wide range of correlation properties,” in Proc. 15^{th} International Conference on Wireless Communications, Vol. 2, Calgary, Alberta, Canada, 2003, pp. 548-552, and in B. Natarajan, S. Das, and D. Stevens, “Design of Optimal Complex Spreading Codes for DS-CDMA Using an Evolutionary Approach,” in Proc. Global Communications Conference, Dallas, November 2004, which are hereby incorporated by reference.

### SUMMARY OF THE INVENTION

The following presents a simplified summary in order to provide a basic understanding of some of the disclosed aspects. This summary is not an extensive overview and is intended to neither identify key or critical elements nor delineate the scope of such aspects. Its purpose is to present some concepts of the described aspects in a simplified form as a prelude to the more detailed description presented in the Detailed Description section.

In view of the foregoing background, aspects of the invention may provide for an asymptotically optimal decoding algorithm to provide for constructing and/or updating a pre-coding matrix in a cooperative-MIMO system. For example, some aspects of the invention may employ a trellis-exploration algorithm similar to a Viterbi algorithm (such as described in A. J. Viterbi, “Error bounds for convolutional codes and an asymptotically optimal decoding algorithm”, IT, Vol. 13, 1967, pp. 260-269, and in A. J. Viterbi, CDMA: Principles of spread spectrum communication. Reading, Mass.: Addison-Wesley Publishing Company, 1995, which are hereby incorporated by reference).

The Viterbi algorithm is a recursive solution to the problem of estimating the state sequence of a discrete-time finite-state Markov process observed in memoryless noise. A traditional trellis-exploration algorithm, such as the Viterbi algorithm, selects a path through a trellis (i.e., a state-transition diagram) that represents the most likely sequence that was generated by a convolutional encoder. At each symbol period, the algorithm generates a branch metric, which is a measure of probability for each branch. A collection of branches through the trellis from a beginning node to an end node is typically referred to as a path. The best path of each state is then determined by examining the accumulated metrics from all paths entering the state and selecting the one with the best metric. Paths with errors accumulate lower metrics, which are discarded, leaving only the path that represents the sequence most likely generated by the convolutional coder.

Trellis-exploration algorithms, such as Viterbi decoding, are not limited to decoding convolutional codes. Rather, in aspects of the invention, such algorithms are applied to other sequence-estimation problems. For example, trellis-exploration algorithms are used for pre-coding in multi-user channels, including subspace channels used for multiplexing and multiple access in MIMO channels.

Aspects of the present invention employ a trellis-exploration algorithm similar to the Viterbi algorithm (and other asymptotically optimal decoding algorithms) to calculate spatial subchannel codes (e.g., beam-forming weights). Such aspects may be directed to cooperative antenna arrays (e.g., cooperative-MIMO systems) and may employ distributed computing.

Aspects of the invention provide for employing metrics, such as correlation metrics, that characterize one or more predetermined relationships between spatial sub-channels for a given set of antenna-array weights being constructed. One aspect of the invention employs a mean-square aperiodic cross-correlation. In another aspect of the invention, an average mean-square autocorrelation is employed. Yet another aspect uses a maximum aperiodic cross-correlation. Alternative aspects of the invention may employ any of a variety of measures to evaluate correlation characteristics of the spreading sequences and/or alternative signal parameters, such as peak-to-average power.

Aspects of the invention may be configurable with any type of cooperative-MIMO system employing various types of MIMO, including, but not limited to, MIMO-OFDM, layered space-time MIMO systems, and MIMO systems employing space-frequency spreading.

One aspect of the invention may employ multiple objectives for pre-coding selection, including spreading to reduce PAPR. Alternatively, other objectives may be employed. Aspects of the invention may provide an iterative approach for calculating a pre-coding matrix without performing a singular value decomposition. Aspects of the invention may provide for an iterative approach for updating a pre-coding matrix. For example, spatial processing may be adapted for changes in the number of spatial subchannels. Furthermore, aspects of the invention may be configured to realize alternative advantages and objectives, as will be apparent to one skilled in the related art.

Some aspects of the invention may provide for multiple iterations through the trellis. For example, a first pass through the trellis may employ incomplete information about the codes if the codes are constructed during the first pass. Subsequent passes through the trellis typically employ complete code sets. Thus, branch metrics may be more complete for subsequent passes in the sense that the metrics are based on complete code sets having a full code length for each code rather than partial code lengths and/or otherwise incomplete code sets. Accordingly, method and apparatus aspects of the invention may be configured to update or improve an existing code set with respect to at least one set of metrics. Code construction may be performed as an iterative procedure comprising multiple passes through a trellis until some predetermined criteria (e.g., a performance measure and/or a number of iterations) is achieved.

Aspects of the invention are directed to calculating antenna-array weights in a cooperative antenna array comprising a plurality of wireless devices. The wireless devices may work together and share information via a WLAN so that in many respects they form a single computer. Thus, aspects of the invention may incorporate distributed computing, which provides for hardware and software systems containing more than one processing element or storage element, concurrent processes, or multiple programs, running under a loosely or tightly controlled regime. In distributed computing, a program is split up into parts that run simultaneously on multiple computers communicating over a network. Distributed computing often requires dividing a program into parts that can run simultaneously.

Aspects of the invention may provide an additional complexity to distributed computing, as they typically involve coordinating an ad-hoc cluster of computational devices (i.e., wireless devices) to function as a single computer for at least some network functions. Such ad-hoc clusters differ from conventional distributed computing environments in that they involve many different owners of computational devices coming together within a redetermined geographical location for a relatively short time to perform a specific task.

In accordance with an aspect of the invention, an apparatus operable in a wireless communication system comprises a trellis-construction module, a fitness function generator, and a processor configured for employing a trellis-exploration algorithm. A trellis is constructed for a number K of spatial sub-channels, a number of antenna-array elements N, and a number L of antenna-weighting parameters. The fitness function is based on estimated antenna-array weights, and the trellis-exploration algorithm is configured for producing updated antenna-array weights.

In accordance with another aspect of the invention, a method used in a wireless communication system comprises constructing a trellis for a number K of spatial sub-channels, a number of antenna-array elements N, and a number L of antenna-weighting parameters; generating a fitness function based on estimated antenna-array weights; and employing a trellis-exploration algorithm for producing updated antenna-array weights.

In accordance with yet another aspect, an apparatus used in a wireless communication system comprises a means for constructing a trellis for a number K of spatial sub-channels, a number of antenna-array elements N, and a number L of antenna-weighting parameters; a means for generating a fitness function based on estimated antenna-array weights; and a means for employing a trellis-exploration algorithm for producing updated antenna-array weights.

In accordance with still another aspect, a machine-readable medium comprises instructions which, when executed by a machine, cause the machine to perform operations, including constructing a trellis for a number K of spatial sub-channels, a number of antenna-array elements N, and a number L of antenna-weighting parameters; generating a fitness function based on estimated antenna-array weights; and employing a trellis-exploration algorithm for producing updated antenna-array weights.

Aspects of the invention may be configurable for generating code sets, updating code sets, and/or reassigning subchannel codes in response to demand for network resources, changes in the number of users accessing the network, individual user-access requirements, changes in signal-propagation characteristics (e.g., multipath, Doppler, path loss, etc.), and/or interference (e.g., ISI, MAI, jamming, etc.). Aspects of the invention may provide for flexible code lengths, sub-array processing, multiple levels of Quality of Service, and/or allow for system overloading. Aspects of the invention may be optimized for minimum processing complexity, such as to enable suitability for real-time applications, rapid updates, low power consumption, and/or low-cost processors. Particular aspects of the invention may be configured to provide for the previously recited features and advantages and/or alternative features and advantages.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

Various aspects of the invention are described in conjunction with the following figures:

FIG. 1 illustrates a method aspect of the invention configured to operate within a Cooperative-MIMO network.

FIG. 2A is a flow diagram of a method configured for calculating antenna-array weights for a plurality of wireless devices in a Cooperative-MIMO system.

FIG. 2B is a trellis diagram employed by aspects of the invention.

FIG. 3 illustrates a method for calculating array weights in a Cooperative-MIMO network comprising a plurality of wireless devices configured to function as an antenna array.

FIG. 4 is a flow diagram depicting a method for calculating antenna-array weights wherein the method employs multiple iterations through a trellis.

FIG. 5 shows a block diagram of a spatial pre-coder according to one aspect of the invention.

FIG. 6 illustrates software components of a coding aspect of the invention residing on a computer-readable memory.

FIG. 7 illustrates a method for managing data and processing for a group of computational devices in a Cooperative-MIMO system.

FIG. 8 shows a block diagram of a MIMO-OFDM system employing a cooperative antenna array in accordance with an aspect of the invention.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

In the following description, for the purposes of explanation, numerous specific details are set forth in order to provide a thorough understanding of the invention. It should be understood, however, that the particular aspects shown and described herein are not intended to limit the invention to any particular form, but rather, the invention is to cover all modifications, equivalents, and alternatives falling within the scope of the invention as defined by the claims.

The articles “a” and “an” as used in this application and the appended claims should generally be construed to mean “one or more” unless specified otherwise or clear from context to be directed to a singular form.

As employed herein the word “processor” refers to a classical architecture or a quantum computer. Classical architecture comprises, but is not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Quantum computer architecture may be based on qubits embodied in gated or self-assembled quantum dots, nuclear magnetic resonance platforms, superconducting Josephson junctions, etc. Processors can exploit nano-scale architectures such as, but not limited to, molecular and quantum-dot based transistors, switches and gates, in order to optimize space usage or enhance performance of user equipment.

In this description, the term “memory” refers to data stores, algorithm stores, and other information stores such as, but not limited to, databases. It will be appreciated that the memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems and/or methods herein are intended to comprise, without being limited to, these and any other suitable types of memory.

Various aspects are described herein in connection with a wireless device. A wireless device can also be called a system, a subscriber unit, subscriber station, mobile station, mobile device, remote station, access point, base station, remote terminal, access terminal, handset, host, user terminal, wireless terminal, terminal, user agent, wireless communication device, user equipment, or some other terminology. A wireless device can be a cellular telephone, a cordless telephone, a Session Initiation Protocol (SIP) phone, a wireless local loop (WLL) station, a Personal Digital Assistant (PDA), a handheld device having wireless connection capability, or other processing device(s) connected to a wireless modem.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips), optical disks [e.g., compact disk (CD), digital versatile disk (DVD)], smart cards, and flash memory devices (e.g., card, stick, key drive).

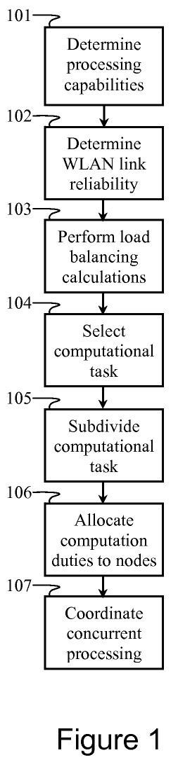

FIG. 1 illustrates a method aspect of the invention configured to operate within a Cooperative-MIMO network. In this aspect, operations for establishing a WLAN group in a Cooperative-MIMO network (such as identifying the availability of each wireless device, assigning the wireless devices to Cooperative-MIMO groups, and synchronizing the wireless devices) have already been performed. Furthermore, operations for managing, coordinating, and updating the Cooperative-MIMO network may be performed concurrently with method aspects of the present invention. In some cases, method aspects may be adapted with respect to such concurrent operations.

A first step 101 provides for determining the processing capability of each wireless device (i.e., node) in a WLAN group within a Cooperative-MIMO network. Processing capability may include, by way of example, but without limitation, availability of the node, memory, CPU processing metrics, and battery power. The processing capability may be reassessed periodically and/or upon one or more event-driven criteria. For example, the first step 101 may be performed for each new node added to the WLAN group. The first step may be performed upon receiving a request from a node indicating that its processing capability has changed. Furthermore, alternative criteria may be employed for updating the determination of processing capability without departing from the scope of the invention.

A second step 102 provides for determining the WLAN link reliability of each node. For example, step 102 may comprise inspecting the communication links between nodes and calculating a link-reliability metric. Since link reliability corresponds to a node's availability, a link-reliability metric may be used to determine whether each node is employed for subsequent signal-processing operations. Accordingly, steps 101 and 102 may be interchanged, or performed concurrently. Aspects of the invention may provide for updating the link-reliability metric for one or more nodes. Such updates may be periodic and/or event-driven. For example, changes in the location of a node and/or variations in channel conditions (e.g., multipath, interference, etc.) may trigger an update. Similarly, WLAN link reliability may be assessed for new nodes added to a WLAN group. Additional and/or alternative criteria may be employed for determining the WLAN link reliability without departing from the scope of the invention.

A third step 103 provides for load-balancing. In computer networking, load balancing distributes work between two or more computers, network links, CPUs, hard drives, or other resources, in order to enable optimal resource utilization, throughput, and/or response time. Using multiple components with load balancing, rather than a single component, may increase reliability through redundancy. The load-balancing step 103 provides for determining how computational and data-storage tasks are assigned to the nodes. The load-balancing step 103 may be updated, and such updates may be periodic and/or event-driven. For example, changes in the availability of nodes, including nodes being added to and/or removed from the WLAN group, may trigger an event to reassess how tasks are distributed. Load-balancing 103 may be performed in coordination with determining processing capability 101 and/or determining WLAN link reliability 102.

A fourth step 104 provides for selecting one or more computational tasks for distributed processing. For example, the one or more computational tasks may be selected based on the availability and computational ability of nodes to perform the processing, and the manner in which load-balancing is established. Selecting one or more computational tasks may be performed to provide for redundancy such that if one or more wireless devices become unavailable, signal processing is not adversely affected. Selecting one or more computational tasks may be performed to reduce processing time by allowing multiple processors to handle different portions of the same computational task. Thus, the fourth step may be adapted in accordance with changing availability of the nodes and/or changing computational requirements.

A fifth step 105 provides for subdividing each computational task with respect to how many processors are available and the processing capability of each processor. This step 105 may be adapted relative to the changing availability of nodes.

A sixth step 106 provides for allocating computational duties to the nodes. For example, such allocations may be made relative to a combination of processing capability, link reliability, and load-balancing calculations. Adaptations and updates to the sixth step 106 may be made with respect to load balancing and/or changing availability of the nodes. In some aspects, steps 105 and 106 may be performed as a single step.

A seventh step 107 provides for coordinating work among concurrent processes. A basic aspect of distributed computing is the method of communicating and coordinating work among concurrent processes. Through various message-passing protocols, processes may communicate directly with one another, typically in a master/slave relationship. Alternatively, a database-centric architecture utilizing a shared database may enable distributed computing without requiring direct inter-process communication.

In one aspect of the invention, the computational task selected in step 104 comprises calculating and/or updating a set of antenna-array weights employed for distributing data across a group of wireless devices functioning as a transmitter array. These antenna-array weights may also be used by the array for receiving signals. Some aspects of the invention may employ various types of asymptotically optimal decoding algorithms, which are well-known in the art, including variations of the algorithm disclosed by Viterbi in “Error bounds for convolutional codes and an asymptotically optimal decoding algorithm”, IT, Vol. 13, 1967, pp. 260-269. In the prior art, Viterbi's algorithm is implemented as a maximum likelihood estimation, which provides an optimization with respect to an error-measurement metric (e.g., bit-error rate). However, aspects of the invention may employ a trellis-exploration type of a maximum likelihood algorithm to provide an estimate of one or more spatial subchannel code sets (i.e., sets of antenna-array weights) based on a corresponding preferred path metric. This estimation may be weighted if necessary.

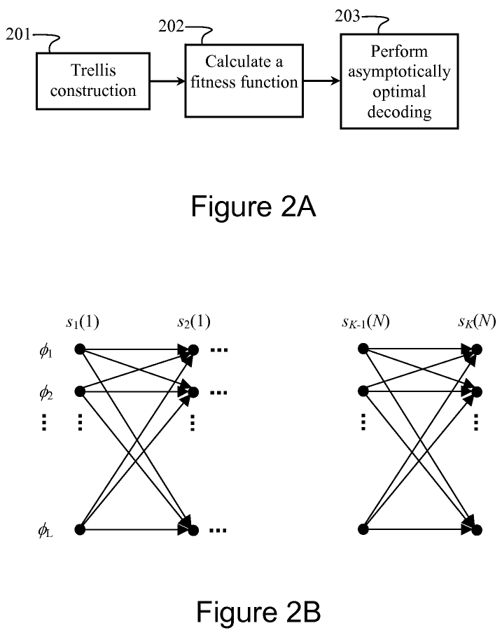

FIG. 2A is a flow diagram of a method configured for calculating antenna-array weights for a plurality of wireless devices configured to operate in a Cooperative-MIMO system. The method comprises constructing a trellis 201, generating at least one fitness function based on estimated antenna-array weights 202, and employing a trellis-exploration algorithm for producing updated antenna-array weights 203. Any of the steps 201-203 represent the one or more computational tasks that may be selected in step 104 for distributed processing.

Trellis construction 201 is performed for a predetermined number K of desired spatial sub-channels, a predetermined number of antenna-array elements (i.e., subchannel code length) N, and a number L of antenna-weighting parameters. In one aspect, each antenna-weighting parameter may include any combination of phase and amplitude. In another aspect, additional or alternative signal parameters may be employed. For example, an antenna-weighting parameter may include antenna polarization. Antenna-weighting parameters may include beam-pattern parameters such as may be characterized by beam direction, beam width, or any other beam-pattern characteristics.

In accordance with one aspect of the invention, each of the N antenna-array elements comprises a wireless device, even if the wireless device comprises more than one antenna. Thus, each antenna-array element may comprise one or more antennas. In another aspect of the invention, each of the N antenna-array elements comprises just one antenna of a wireless device. Thus, a wireless device having n antennas comprises n antenna-array elements.

In one aspect of the invention, a trellis having K×N state transitions (such as illustrated in FIG. 2B) is constructed based on the number of desired spatial sub-channels K in the system, the number of antenna-array elements N, and L discrete (i.e., unique) phases φ₁, . . . , φ_{L} to be used as antenna weights of a spatial sub-channel code set. One of ordinary skill in the art will appreciate that a trellis can be regarded as a representation of computational procedures performed by a signal-processing module comprising a combination of hardware and software components. Thus, trellis construction 201 may comprise initializing trellis signal-processing algorithms with respect to a set of input parameters, such as K, N, L, and φ₁, . . . , φ_{L}. Trellis parameters and trellis operations may be embodied within algorithms, computational processes, and even hardware employed by the present invention.

The trellis includes K×N state transitions wherein each transition point is characterized by L nodes, or states. Each transition point may correspond to a particular antenna weight (i.e., spatial subchannel code chip) for a given spatial sub-channel. For example, a sequence of transition points in a lattice may correspond to elements of a particular code set having the following order

{u₁(1), u₂(1), . . . , u_{K-L}(N), U_{K}(N)}

where uₖ(n) corresponds to an n^{th} array weight of a k^{th} spatial sub-channel. In this case, the n^{th} array weight for each of the K spatial sub-channels is assigned before proceeding to the (n+1)^{th} array weight. This topology may be classified as a by-element variant.

In an alternative aspect of the invention, the trellis may be constructed with a code set ordered as

{u₁(1), u₁(2), . . . , u_{K}(N−1), u_{K}(N)}

This variant is a by-subchannel variant, since all N antenna weights of a k^{th} spatial sub-channel are assigned before proceeding to the next (k+1)^{th} spatial sub-channel. In general, these two variants may provide slightly different final code sets that have similar cross-correlation characteristics.

The scope of the invention should not be interpreted as being limited to the type of ordering illustrated in the aspects. Rather, the Applicants anticipate that alternative code-set orderings may be implemented, and that such orderings fall within the scope of the invention.

Interconnects may be made between each of the L nodes (e.g., nodes φ₁, . . . , φ₄) at a transition point p to each of the L nodes of an adjacent transition point p+1. Although the illustrated trellis suggests that an equal number L of nodes exists for each transition point and that each node has L possible interconnects, it should be appreciated that the number of nodes L and the number of possible interconnects may differ between aspects. For example, certain aspects of the invention may provide for reducing the number of possible interconnects. Some aspects of the invention may also vary the number of nodes L in the lattice.

The L nodes correspond to L candidate antenna weights, or subchannel code chip values, νₗ, where lε{1, . . . , L}. In one aspect of the invention, polyphase code-chip values φ₁, . . . , φ_{L} may be employed. Thus, the candidate code chip values νₗ=φₗ may be expressed as

$${φ}_{l} = exp ( \frac{2 π l}{L} ) .$$

In some aspects of the invention, alternative selections of phases φ₁, . . . , φ_{L} may be employed. For example, non-uniformly spaced phase elements may be used. Although the exemplary code-chip values illustrated herein represent constant-modulus codes, aspects of the invention may provide for complex-valued codes that include a non-uniform amplitude component. Code-chip values employed herein may alternatively comprise only a variable-amplitude component. Further variations of the invention may provide for different code-chip constellations for different transition points. For example, phase-rotated sets of complex code-chip values may be provided relative to each transition point.

In yet another aspect of the invention, a predetermined set of candidate code chips may be weighted with a complex channel-scaling factor. For example, the channel-scaling factor may comprise a vector of spatial sub-channel equalization values to equalize the set of spatial sub-channels. Scaling factors may employ any of well-known channel pre-coding techniques.

For each node at a transition point in the trellis, a path terminating at one of the nodes of the previous transition point is selected based on a predetermined fitness function as part of the trellis-exploration algorithm 203. In one aspect, the fitness function may comprise an average mean-square aperiodic cross correlation R_{CC} of the codes. However, alternative correlation functions (as well as other fitness functions) may be employed. An aperiodic autocorrelation may be used for reducing peak-to-average-power ratio (PAPR). Alternatively, the fitness function may use a Fourier transform of an aperiodic autocorrelation to shape the code's power spectral density, which may be advantageous for mitigating interference.

The average mean-square cross correlation R_{CC} is described mathematically as

$${R}_{CC} = \frac{1}{K ( K - 1 ) {N}^{2}} {\sum }_{x = 1}^{K} {\sum }_{y = 1 , y \neq x}^{K} {\sum }_{l = 1 - N}^{N - 1} {α}_{l} {\vert {C}_{xy} ( l ) \vert}^{2}$$

where K is the number of spatial sub-spaces in the code set, C_{xy}(l) is the aperiodic correlation function between two codes corresponding to an l^{th} multipath delay, and αₗ is a complex-valued scaling factor for the l^{th} multipath. The term C_{xy}(l) is expressed by

$${C}_{xy} ( l ) = \{ \begin{matrix}{\sum }_{k = 0}^{N - 1 - l} {u}_{x} ( k ) {u}_{y}^{*} ( k + 1 ) & 0 \leq l \leq N - 1 \\ {\sum }_{k = 0}^{N - 1 + l} {u}_{x} ( k - l ) {u}_{y}^{*} ( k ) & 1 - N \leq l \leq 0 \\ 0 & otherwise\end{matrix}$$

where uₓ and u_{y} represent subspace code chip values (i.e., antenna-array weights) for a spatial sub-channel x and a spatial sub-channel y, respectively. One aspect of the invention provides for normalizing R_{CC} relative to antenna-array length N to facilitate comparisons between sub-space codes of different lengths.

A mean-square measure for autocorrelation is given by

$${R}_{A C} = \frac{1}{{KN}^{2}} {\sum }_{x = 1}^{K} {\sum }_{l = 1 - N , l \neq 0}^{N - 1} {α}_{l} {\vert {C}_{xx} ( l ) \vert}^{2}$$

A relationship between R_{CC} and R_{AC} is given as follows:

R_{AC}≧(K−1)(1−R_{CC})

Thus, the maximum-square aperiodic cross-correlation profile may be represented as the maximum value of the cross-correlations between signature sequences of any two spatial sub-spaces at some relative offset

Rₘₐₓ(l)=max(|C_{xy}(l)|²)∀x,yε{1, . . . , K},

which is defined for all relative delays l. An absolute maximum-square aperiodic cross correlation R_{Max} is defined as the maximum value of Rₘₐₓ(l) over all l. Thus, R_{Max} represents a worst-case BER that can occur due to MAI.

In a MIMO-OFDM aspect employing adequate cyclic prefixes, the sum over multipaths may be removed. In a space-frequency aspect with cyclic prefixes and spreading across OFDM subcarriers, the sum over multipaths may be replaced by a sum over subcarriers. Some aspects of the invention may be configured to produce code sets characterized by a predetermined relationship between R_{Max}, R_{AC}, and R_{CC}.

In one aspect of the invention, each node at a transition point p may be joined to a path terminating at one of the nodes of the previous transition point (p−1). Selection of a “winning” path is performed by appending the code value corresponding to the particular node at transition point p to a code sequence corresponding to a path terminating at transition point p−1 based on the predetermined fitness function. A candidate path ending at transition point p−1 may be selected more than once by nodes at point p. Accordingly, one or more candidate paths at point p−1 may not be selected, and thus, can be removed from consideration. Thus, for each transition point, there are L active paths. Some aspects of the invention may be configured to provide an approximation to the fitness function, such as by employing only a portion of the total K×N code-set matrix.

Various aspects of the invention may provide for different decision mechanisms, such as when more than one candidate path in the trellis achieves the same minimum value of R_{CC} for the current node under consideration. Typically, the decision rule in convolutional decoding and MLSE reception has been to follow a pre-defined convention, such as selecting the first path encountered with the minimum value of the error function. However, certain aspects of the invention may have many instances in which multiple paths achieve the same R_{CC} at a particular node. In these cases, employing a typical prior-art decision rule may substantially limit the code-set search space. Accordingly, aspects of the invention may implement a deterministic decision rule. For example, the decision rule may be configured to select a path from the set of all paths having the minimum R_{CC} value such that:

p=(k+n+l+i)mod T

where p is the selected index among the set of paths having the minimum R_{CC}, k is the subchannel associated with the particular antenna-array weight currently being evaluated, n is the index into the code for the code chip currently under consideration, l is the index of the candidate phase, i is the number of iterations through the trellis at the present time, and T is the number of elements in the set of paths reaching the minimum R_{CC}. This exemplary decision rule can step sequentially through the paths with respect to indices k, n, l, and i. Thus, if for a particular k, n, and l, there are the same number of elements in the set of minimum-R_{CC} paths from one iteration to the next, the algorithm will step through them sequentially over each iteration, giving each path the opportunity to be selected. This same property exists for each of the other three parameters as well, thus, introducing the needed diversity while also being deterministic and, therefore, repeatable over independent executions of the algorithm.

In one aspect of the invention, the sub-divide step 105 comprises selecting a plurality of different weight-calculation techniques to be employed simultaneously by a plurality of computational devices (e.g., wireless devices) for calculating optimal antenna-array weights (i.e., spatial sub-channel codes). For example, one computational device may be configured to perform the by-element variant topology (wherein each n^{th} element for all of the codes is calculated before moving to the next (n+1)^{th} element), and another computational device may be configured to perform the by-subchannel variant topology, wherein each sub-channel code is calculated in its entirety before calculating the next sub-channel code. Results of the calculations may be compared or evaluated with respect to at least one performance criteria, and the optimal code set selected.

In another aspect of the invention, the sub-divide step 105 is configured to direct each of a plurality of computational devices to follow a different path through the trellis when more than one candidate path in the trellis achieves the same minimum value. In some aspects, each computational device may employ a different decision rule for selecting one of the paths.

Aspects of the invention may simultaneously employ a variety of array-weight constellations for calculating optimal antenna-array (i.e., beamforming) weights. For example, the sub-divide step 105 comprises allocating a different set of phase codes as possible code-set values to be used in calculations performed by each of a plurality of computational devices. Such phase-code sets may include binary phase, quadrature-phase, and differently phase-rotated code-chip values per transition point. Alternative types of phase coding may be employed as well. In some aspects, the amplitude component may be non-uniform. Specifically, different amplitude constellations may be considered by different computational devices configured to work together for calculating an optimal code set.

In another aspect of the invention, the sub-divide step 105 comprises directing each of a plurality of computational devices to employ different numbers of nodes, different interconnects, different code-chip values, and/or different fitness functions (including different approximations to a particular fitness function).

Each of these approaches provides for some degree of redundancy in the calculation of antenna-array weights. Specifically, each approach allows for one or more of the computational devices to fail as long as at least one of the computational devices succeeds in its calculations and is able to convey its result.

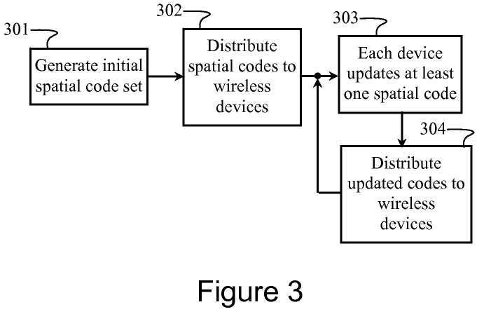

FIG. 3 illustrates a method for calculating array weights in a Cooperative-MIMO network comprising a plurality of wireless devices configured to function as an antenna array. A preliminary set of spatial codes (i.e., seed codes generated 301 from a first pass through the trellis or generated from alternative calculations) is distributed to a plurality of the wireless devices 302. Each device calculates an updated spatial code for its assigned subchannel 303. The improved spatial codes are first-iteration codes, which are distributed 304 to the plurality of wireless devices. The wireless devices may employ the updated codes for processing transmitted signals as well as received signals. Alternatively, a subsequent iteration may be performed, which comprises repeating the update step 303. The newly updated codes may be used to process transmission signals by the wireless devices. Alternatively, upon a final iteration, the distribution step 304 may be adapted to couple the updated codes to a single processor or a group comprising a different set of processors (which may or may not comprise any of the computational devices) configured for processing transmission signals. The process of distributing 304 updated codes to the wireless devices is repeated 304 a predetermined number of iterations, or until a predetermined criterion metric is satisfied. The process may be resumed to update the spatial codes as channel conditions change. The process may be resumed upon the addition or deletion of a wireless device to the Cooperative-MIMO array, or any other activity that changes the number of spatial subchannels employed by the array.

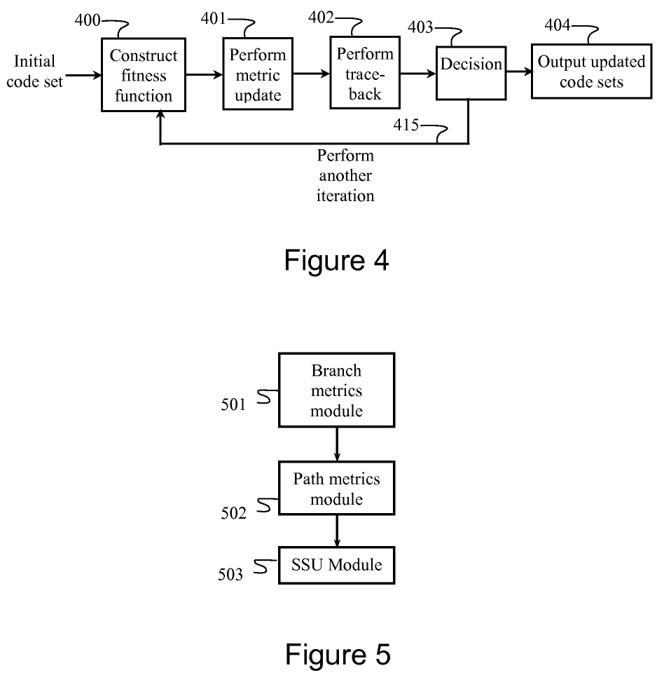

FIG. 4 is a flow diagram depicting a method for calculating antenna-array weights employing multiple iterations through a trellis. In one aspect of the invention, steps 400-402 may be performed by each of a plurality of wireless devices in a cooperative antenna array network. Steps 403-404 may be performed by a central processor or distributed processor using updated code sets output by the plurality of wireless devices. In another aspect of the invention, steps 400-403 may be performed by each of a plurality of wireless devices in a cooperative antenna array network, and step 404 may be performed by a central processor or distributed processor using updated code sets output by the plurality of wireless devices. Other aspects of the invention may provide for alternative allocations of the steps 400-404 between the wireless devices and the central processor or distributed processor.

Aspects of the invention may employ iterative decoding techniques (such as described in Q. Wang and L. Wei, “Graph-Based Iterative Decoding Algorithms for Parity-Concatenated Trellis Codes,” IEEE Trans. Information Theory, Volume: 47 Issue: 3, March 2001 Page(s): 1062-1074, which is hereby incorporated by reference) for generating antenna-array weights used to construct spatial sub-channels in a Cooperative-MIMO system.

Various methods may be employed for generating initial antenna-array weights, which are labeled as an “Initial code set” in FIG. 4. In one aspect of the invention, a predetermined code set is used as the initial code set. In another aspect, the initial code set may be derived from a first pass through the trellis. In a first pass through the trellis, the first N−1 antenna-array weights (i.e., spatial code values) of each spatial sub-channel (i.e., sub-channel code) may be selected based on incomplete information because the calculation of the fitness function does not employ subsequent antenna-array weights that are determined later. Since an optimal path may not be selected during the first pass, multiple iterations (i.e., traversals) through the trellis may be performed. When the first pass through the trellis is complete, L complete candidate code sets have been built.

The trellis is initialized 400 by employing the current antenna-array weights in the fitness function. Branch metrics are calculated using the fitness function as part of a metric update 401. Thus, the implementation of the fitness function for the first N−1 antenna-array weights of each subchannel can exploit the full code-set length N.

A trellis-exploration algorithm may be broken down into metric update 401 and traceback operations 402. In metric update 401, an accumulated state metric is calculated for each state, and the optimal incoming path associated with each state is determined. Traceback 402 uses this information to derive an optimal path through the trellis for updating the set of antenna-array weights. In one aspect of the invention, at each node of the trellis, branch metrics are added to one or more path metrics calculated at the previous node. The new path metrics are compared, and at least one path corresponding to an optimum path metric is selected.

A decision process 403 may be provided for determining whether to repeat the trellis operations 400-402 or output the current code sets 404 for further processing (not shown). Such determinations are typically made with respect to an evaluation of the metrics and/or a count of the number of iterations performed. Aspects of the invention may employ any combination of decision metrics for determining whether to repeat the trellis operations 400-402. Each subsequent iteration 415 through the trellis causes the fitness function to asymptotically approach an optimal (e.g., minimum) value. Typically, a saturation point is reached after a certain number of iterations.

Some aspects of the invention may employ multi-objective versions of an asymptotically optimal decoding algorithm. In one aspect, metrics used to evaluate the multiple objectives may be combined into a single metric. For example, if it is desirable to evaluate two objectives f(U) and g(U), where U denotes the code matrix. A combined objective function h(f(U); g(U)) may be used to evaluate each node of the trellis.

An alternative aspect may be based on Pareto optima. The Pareto optima are the subset of a population for which no other individual element in the population has superior characteristics in all objectives under consideration. The first iteration is completed in order to provide a complete code set U for constructing the fitness function 400. At each stage or node of the trellis, the fitness function involves deterministically selecting one of the objectives as the evaluation metric for that stage or node 401. An optimal path under the chosen metric is selected at each node 402, followed by the decision process 403.

The decision process 403 may maintain a table of the Pareto optima by considering each of the objectives at a particular node, and if one is found that belongs to the set of Pareto optima, it is added to the table of Pareto optima. Thus, the decision process 403 may include comparing the metrics of each candidate path to those of each element of the Pareto optima. If a particular element of the Pareto optima is better in every metric than the candidate path, then the candidate path is discarded because it cannot belong to the set of Pareto optima. If none of the Pareto optima elements dominates a candidate path, then the candidate path is added to the table. Any elements of the current Pareto optima that are dominated by the candidate path are subsequently deleted.

FIG. 5 is a block diagram of a spatial pre-coder according to one aspect of the invention. A branch metrics module 501 is configured for computing a branch metric for an antenna-array weight candidate corresponding to each of the possible transitions (i.e., weight values). An accumulated metrics module, such as a path metrics module 502, is configured to operate at each node of the trellis to add branch metrics to one or more previous path metrics, compare the new path metrics, and select at least one new optimum path metric. A survivor storage and updating (SSU) module 503 may be configured to store decisions (also called “survivors”) coming from the accumulated metrics module and provide a trace-back of the paths, such as is well-known in the art of Viterbi decoding.

It should be appreciated that the apparatus shown in FIG. 5, as well as method aspects of the invention, may be implemented using a variety of hardware and software. For example, portions of the pre-coder may be implemented using special-purpose hardware, such as an application specific integrated circuit (ASIC) and programmable logic devices such as gate arrays, and/or software or firmware running on a computing device, such as a microprocessor, microcontroller or digital signal processor (DSP). It also will be appreciated that although functions of the pre-coder may be integrated in a single device, such as a single ASIC, they may also be distributed among several devices.

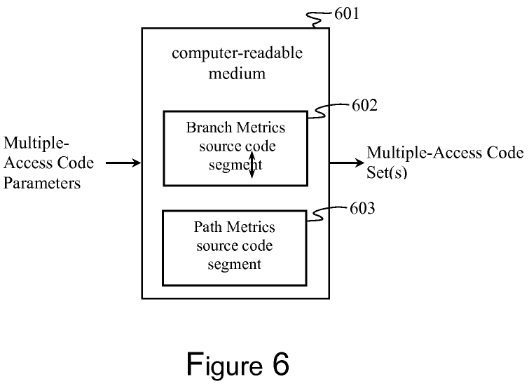

FIG. 6 shows software components of a coding aspect of the invention residing on a computer-readable memory 601. A branch-metrics module 602 is adapted to receive as input one or more multiple-access code parameters, such as code length, number of codes and/or users, and at least one constellation of possible code-chip values. The branch-metrics module 602 is configured for calculating branch metrics for each possible state transition between two successive states. The branch-metrics module 602 may be configured to produce and/or calculate a fitness function based on an asymptotically optimal decoding algorithm (such as a trellis-exploration algorithm similar to a Viterbi algorithm) to provide for constructing a multiple-access code set. Furthermore, the branch-metrics module 602 may construct a trellis.

A path-metrics module 603 is configured for calculating path metrics for possible paths, which result from successive state transitions. For each node in a state, the path-metrics module 603 may be further configured to select a path having an optimal path-metric value and output at least one multiple-access code set corresponding to a set of optimal paths. The branch-metrics module 602 and the path-metrics module 603 may be configured to perform multiple iterations through a trellis.

A dramatic reduction of the total algorithmic complexity can be achieved by exploiting certain properties of the trellis, as well as those of the cross-correlation operation used to compute R_{CC}. It is quite straightforward to see that there are V=L²NK function evaluations for each iteration through the trellis.

To calculate R_{CC}, it is typically necessary to perform K(K−1)/2 aperiodic cross correlation operations of complex-variable vectors of length N. Assuming that a Fast Fourier Transform (FFT) approach is taken to compute each of these correlations, the complexity of the function evaluation in terms of complex multiplication and additions (MADs) is O((N log N)K²), which must be computed V times, leading to an overall complexity of O(L²(N² log N)K³).

Particular aspects of the invention may be configured to reduce the overall complexity. For example, for each candidate phase at each stage of the trellis, a single element is appended to a single subchannel's code and R_{CC} is recalculated. This single element can be shown to affect the cross-correlation matrix in exactly N locations of each of the (K−1) cross-correlations between that subchannel and every other subchannel (disregarding autocorrelations). Thus, a simplification of this algorithm may involve maintaining a cross-correlation matrix Aₗ for each candidate path through the trellis and updating the matrix Aₗ by adding the effects of the current candidate phase at the corresponding N(K−1) locations and summing the new result to get the new value of R_{CC}. The simplified algorithm repeats this procedure V times, resulting in a total computational complexity of only O(L²N²K²).

The aperiodic cross-correlation between two subchannel codes, uₓ and u_{y} is given by

C_{xy}=(C_{xy}(1−N), . . . , C_{xy}(N−1))^{T}

where C_{yx} is simply the mirror image of C_{xy}. The R_{CC} metric is based on the accumulated moduli of the aperiodic cross-correlation values at each tap delay, and for each pair of subchannels (x, y), it is sufficient to consider only one of C_{xy} and C_{yx}. Thus, the aperiodic cross-correlation matrix Aₗ has a size K(K−1)/2×(2N−1), where l denotes the index of the path to which it corresponds. The matrix Aₗ has row entries

Aₗ=(C₁₂^{T}, C₁₃^{T}, . . . , C_{1K}^{T}, C₂₃^{T}, . . . , C_{K-1,K}^{T})^{T}

such that, for every code pair (x, y), there is no corresponding pair (y, x).

Upon appending element uₓ(m) to a current path through the trellis, the following algorithm may be used to update the corresponding cross-correlation matrix Aₗ

Algorithm 1: Low-complexity R_{CC} update
Require: Aₗ, U and new element uₓ(m)
Ensure: one-indexing

for ∀_{y} < x do

$k ← ( y - 1 ) ( K - 1 ) - \frac{( y - 1 ) ( y - 2 )}{2} + ( x - y )$
for p = m to m + N − 1 do

Aₗ(k, p) ← Aₗ(k, p) + u_{y}(p − m + 1)uₓ^{*}(m)

end for

end for
for ∀_{y} > x do

$k ← ( x - 1 ) ( K - 1 ) - \frac{( x - 1 ) ( x - 2 )}{2} + ( y - x )$
for p = N − m + 1 to 2N − m do

Aₗ(k, p) ← Aₗ(k, p) + u_{y}^{*}(2N − m + 1 −

p)uₓ(m)

end for

end for

There are two notable differences between the two for loops. The first loop uses the conjugate of the newly-appended element, uₓ(m), whereas the second loop uses the conjugate of the code entries from the other subchannels' codes. Secondly, the algorithm loops through the elements of each u_{y} in forward order in the first loop and in reverse order in the second loop. To calculate the new value for R_{CC}, it is necessary to subtract out the moduli of the affected elements before performing the update algorithm, and then add in the moduli of the affected elements after the algorithm is run. Thus, this full update algorithm has complexity O(NK), since there are N(K−1) elements affected in each of these operations. In contrast, conventional computational-intelligence approaches recalculate the entire R_{CC} metric for each function evaluation, resulting in a complexity of O((N log N)K²).

Variations of the previously disclosed aspects may be provided for reducing computational complexity. For example, the relationship

$${\sum }_{k = 0}^{K - 1} {\sum }_{m = 0}^{K - 1} ( {\sum }_{l = 1 - N}^{N - 1} {\vert {C}_{m , k} ( l ) \vert}^{2} ) = {K}^{2} {N}^{2} + 2 {\sum }_{l = 1}^{N - 1} {\vert {\sum }_{k = 0}^{K - 1} {C}_{k , k} ( l ) \vert}^{2}$$

may be exploited to produce the equation

$${R}_{CC} = 1 - \frac{{R}_{A C}}{K - 1} + \frac{2}{{KN}^{2} ( K - 1 )} {\sum }_{l = 1}^{N - 1} {\vert {\sum }_{k = 0}^{K - 1} {C}_{k , k} ( l ) \vert}^{2} .$$

Thus, in order to calculate both R_{AC} and R_{CC}, it is only necessary to consider the aperiodic autocorrelation matrix. At a particular stage of the trellis, a single element of a single subchannel's code affects only one row of the aperiodic autocorrelation matrix. Furthermore, since the aperiodic autocorrelation is symmetric about zero lag, and the autocorrelation at zero lag is ignored in the previous equation, it is sufficient to consider only positive lags.

The last term in the previous equation simply consists of the moduli of the sums of the complex-valued aperiodic autocorrelations at a particular lag for each subchannel. Thus, at each stage of the trellis, an algorithm in accordance with one aspect of the invention may calculate the new aperiodic autocorrelation for a single subchannel. The algorithm may keep a separate N−1 length vector of summed columns of the aperiodic autocorrelation matrix, since only these N−1 complex values need to be updated. The moduli of the updated complex values are summed to calculate an updated R_{CC} metric.

In this aspect, an update of the R_{CC} metric requires only O(N) complex MADs at each stage of the trellis (N complex MADs to update the aperiodic autocorrelation matrix and N complex additions and norm calculations, followed by an N-length real-valued summation). The computational complexity of this algorithm is O(L²N²K). This algorithm also provides a reduced memory overhead of O(LNK), since it does not require storing matrix Aₗ for its implementation, but rather, needs only to store the aperiodic autocorrelation matrix, plus an additional N−1 length vector for each active trellis path.

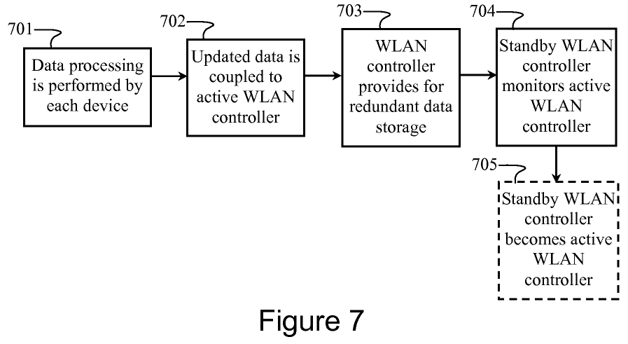

FIG. 7 illustrates a method for managing data and processing for a group of computational devices in a Cooperative-MIMO system. Each of the group of computational devices performs data processing operations 701, and those operations are coordinated by at least one active WLAN controller. The active WLAN controller provides data communications to and from each of the computational devices. Thus, data produced by processing operations on each of the computational devices is coupled to the active WLAN controller 702. The active WLAN controller provides for redundant data storage 703. Data storage 703 may be provided by distributing all the data to the computational devices and/or to a plurality of other devices configured for storing data.

In one aspect of the invention, the active WLAN controller performs data-processing operations, including data read/write operations to and from the storage apparatuses, while at least one additional computational device is in a standby state as a standby WLAN controller. A standby WLAN controller monitors the status of the active WLAN controller 704. In an optional step 705, the standby WLAN controller may become the active WLAN controller. For example, if a failure occurs on the active WLAN controller, the standby WLAN controller detects the failure and takes over the data-processing operations 705. Alternatively, the standby WLAN controller may become the active WLAN controller 705 as determined by a load-balancing operation. Alternative aspects of the invention may provide other reasons and/or methods in which a standby WLAN controller becomes the active WLAN controller.

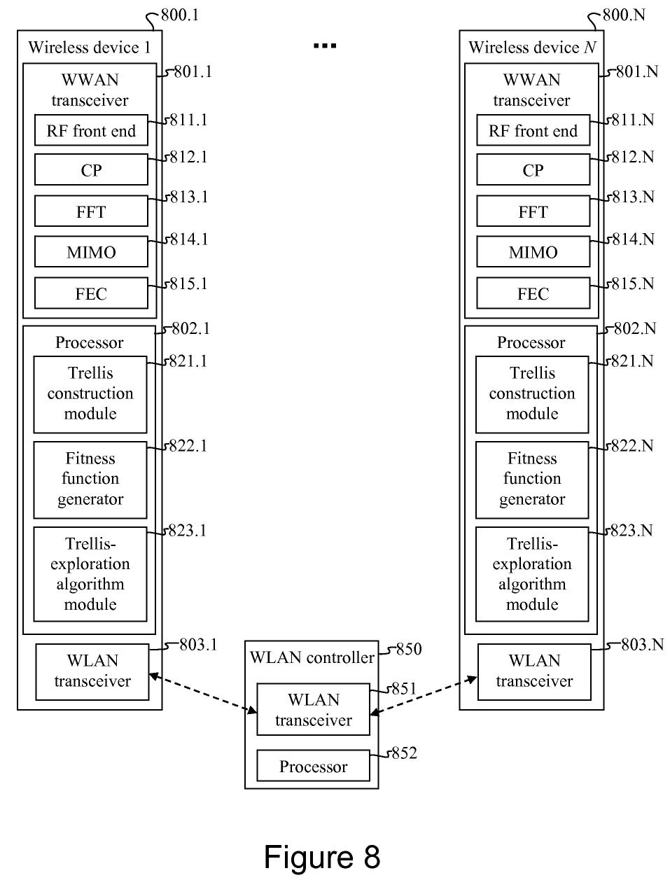

FIG. 8 shows a block diagram of a MIMO-OFDM system employing a cooperative antenna array in accordance with an aspect of the invention. A plurality N of wireless devices 800.1-800.N are communicatively coupled to a WLAN controller 850. The WLAN controller 850 comprises a WLAN transceiver 851 and a processor 852. The WLAN transceiver 851 is configured to coordinate WLAN communications between the wireless devices 800.1-800.N. For example, the WLAN transceiver 851 may allocate WLAN channels to the wireless devices, manage the WLAN as wireless devices enter and leave the network, and provide other network-management services, such as is well-known in the art.

The processor 852 may be configured for coordinating computational processing performed by one or more of the wireless devices 800.1-800.N. For example, the processor 852 may provide for data sharing between the wireless devices 800.1-800.N. In some aspects of the invention, the processor 852 may perform computational processing on data received from the wireless devices 800.1-800.N. For example, the processor 852 may be configured for performing MIMO processing. The processor 852 may be configurable for storing data and/or directing data to be stored on one or more of the wireless devices 800.1-800.N. In some aspects, the processor 852 coordinates the interaction of the wireless devices 800.1-800.N with a wireless wide area network (WWAN), such as a cellular network. For example, the processor 852 may direct the timing of operations performed by the wireless devices 800.1-800.N such that the wireless devices 800.1-800.N perform as a cooperative antenna array. The processor 852 may control a trellis-exploration algorithm, assign antenna-array weights to the wireless devices 800.1-800.N, allow sharing of WWAN access information between the wireless devices 800.1-800.N, and coordinate the timing of transmissions into the WWAN channel.

Each of the wireless devices 800.1-800.N, such as wireless device 800.1, comprises a WWAN transceiver 801.1, a processor 802.1, and a WLAN transceiver 803.1. The WWAN transceiver 801.1 communicatively couples the wireless device 800.1 to the WWAN. The processor 802.1 is configured for calculating antenna-array weights for at least one of the wireless devices 800.1-800.N functioning as a cooperative antenna array. The WLAN transceiver 803.1 communicatively couples the wireless device 800.1 to the WLAN. Each WWAN transceiver, such as WWAN transceiver 801.1, comprises an RF front end 811.1 for interfacing with the WWAN channel, a cyclic prefix module (CP), a fast Fourier transform (FFT) module 813.1, a MIMO module 814.1, and a forward-error-control (FEC) module 815.1.

The forward-error-control (FEC) module 815.1 is configurable to provide channel coding (e.g., convolutional coding, block error-correction coding, etc.) to at least one user data stream for transmission. The FEC module 815.1 also performs FEC decoding to data received from the WWAN channel. The MIMO module 814.1 applies spatial or space-frequency pre-coding to each user's data stream. Spatial precoding may comprise channel codes applied across the antenna array (i.e., the plurality of the wireless devices 800.1-800.N) for each OFDM tone. Space-frequency pre-coding comprises channel coding across multiple OFDM tones, in addition to coding across the antenna array.

The MIMO module 814.1 employs code sets generated from a trellis-exploration algorithm employed by the processors 802.1-802.N. In one aspect of the invention, multiple code sets are generated by the processors 802.1-802.N and one of the code sets may be selected by the processor 852 in the WLAN controller 850. In another aspect of the invention, each processor 802.1-802.N generates its own code set based on information about code sets produced by the other processors 802.1-802.N. The MIMO module 814.1 may employ the code sets for transmitter and/or receiver weights employed by the wireless devices 800.1-800.N.

The FFT module 813.1 modulates the coded data onto a predetermined set of orthogonal subcarriers. The FFT module 813.1 may also demodulate a received OFDM signal into its sub-carrier values. A cyclic prefix (CP) module 812.1 is configured for adding a cyclic prefix to the modulated OFDM signal. The CP module 812.1 is also configured for removing a cyclic prefix from a received OFDM signal. An RF front-end 811.1 is configured for conditioning the modulated signals for transmission into the WWAN channel and for converting received signals into baseband signals.

In one aspect of the invention, each processor 802.1-802.N comprises a means for constructing a trellis, a means for generating a fitness function based on estimated antenna-array weights, and a means for employing a trellis-exploration algorithm for producing updated antenna-array weights.

The means for constructing the trellis may comprise a trellis construction module 821.1. The trellis construction module 821.1 comprises, by way of example, but without limitation, any combination of hardware and software configured to construct a trellis for a number K of spatial sub-channels, a number of antenna-array elements N, and a number L of antenna-weighting parameters.

The means for generating the fitness function may comprise a fitness function generator 822.1. The fitness function generator 822.1 comprises by way of example, but without limitation, any combination of hardware and software configured to generate at least one fitness function. The fitness function is based on antenna-array weights calculated for the wireless devices 800.1-800.N and is used by the trellis exploration algorithm. In accordance with one aspect of the invention, the fitness function may comprise an average mean-square aperiodic cross correlation R_{CC} of the spatial subchannel codes.

The means for employing the trellis-exploration algorithm may comprise a trellis-exploration algorithm module 823.1. In accordance with one aspect of the invention, the trellis-exploration algorithm module 823.1 comprises by way of example, but without limitation, any combination of hardware and software configured to compute a branch metric for each of a plurality of antenna-array weight candidates, add the branch metrics to at least one previous path metric, and select at least one path having an optimum path metric.

A transmitter array comprising the plurality of wireless devices 800.1-800.N includes a plurality N_{T} of transmit antennas, which couples an OFDM signal into a WWAN channel denoted by channel matrix H. A receiver (not shown) comprising an array of N_{R} antennas couples received signals from the channel. The received signals are stripped of their cyclic prefixes, processed by an FFT, matched filtered, and then FEC-decoded.

For each frequency subchannel in a MIMO-OFDM system employing only spatial spreading, a received signal at an N_{R}-element receiver array is expressed by

r=HPb=H_{eff}b,

where b is an N_{T}×1 transmitted symbol vector, P is an N_{T}×N_{T} spatial pre-coding matrix that spreads each symbol vector across the N_{T} transmit antennas, H_{T} is an N_{R}×N_{T} channel matrix characterizing the propagation channel between the N_{T} transmit antennas and the N_{R} receive antennas, and H_{eff} is an N_{R}×N_{T} matrix comprising a product of the matrices H and P.

Due to the computational complexity of inverting H_{eff}, and by virtue of the relative temporal stability of the channel, an iterative solution is easily employed at the receiver. Typically, parallel or serial interference cancellation is employed. In OFDMA systems, channel precoding is an attractive option, since each user employs all of the spatial subchannels within their allocated frequency subchannel(s).

Parallel interference cancellation already employs a channel-correlation matrix R_{CC}=H_{eff}H_{eff}^{H}. Thus, an optimal pre-coding matrix S may be calculated using a trellis-exploration algorithm or a similar search algorithm employing a fitness function that is a function of the eigenvalues of R_{CC}. For example, since the similarity in eigenvalues of R_{CC} denotes system capacity, a path through the trellis may be selected based on candidate P-matrix values that minimize differences between the eigenvalues. Similarly, mean square error may be used as a fitness function to be minimized by path selection through the trellis. Other fitness functions may be used as well. Either the receiver or the transmitter may calculate the precoding matrix P.

If wireless devices in the communication system employ time-division duplexing to use the same subcarrier frequencies for uplink and downlink, and the channel is slowly varying, the forward and reverse channels may be approximately equal. Thus, a pair of wireless devices communicating with each other may calculate respective precoding matrices jointly without having to exchange channel information.

In another aspect, a user may employ multiple subcarrier frequencies, and precoding (e.g., spreading) may be performed across the subcarrier frequencies as well as the spatial subchannels. Aspects of the invention may be configured for alternative types of systems employing MIMO. For example, a Cooperative-MIMO system configured in accordance with one aspect of the invention may provide for layered space-time MIMO precoding. In an alternative aspect of the invention, a method and apparatus of the invention may be configured to employ eigenmode spatial processing.

For a single subcarrier in a MIMO-OFDM system, the MIMO channel formed by the N_{T} transmit antennas at the transmitting entity and the N_{R} receive antennas at the receiving entity may be characterized by an N_{R}×N_{T} channel matrix H (having N_{R} rows and N_{T} columns) comprising elements hᵢⱼ, for i=1 . . . N_{R} and j=1 . . . N_{T}, denotes the coupling or complex gain between transmit antenna j and receive antenna i. For simplicity, aspects of the invention are described with the assumption that the MIMO channel is full rank (i.e., N_{S}=N_{T}≧N_{R}).

The channel matrix H comprises a spatial processing (or pre-coding matrix) and a spatial-matched filtering matrix, in addition to a channel-response matrix that characterizes spatial correlations between the transmitter array and the receiver array. The singular value decomposition of the channel matrix H may be expressed as:

H=UΣV^{H},

where U is an N_{R}×N_{R} unitary matrix of left eigenvectors of H, Σ is an N_{R}×N_{T} diagonal matrix of singular values of H, and V is an N_{T}×N_{T} unitary matrix of right eigenvectors of H.

The right eigenvectors of H (which are the columns of V) may be used as a matrix of steering vectors for spatial processing by the transmitting array to transmit data on the N_{S} eigenmodes of H. The left eigenvectors of H (which are the columns of U) may be used for spatial matched filtering by the receiving array to recover the data transmitted on the N_{S} eigenmodes. The eigenmodes may be viewed as orthogonal spatial channels obtained through decomposition. The diagonal elements of Σ are referred to as the singular values of H and represent the channel gains for the N_{S} eigenmodes of H. Diagonalization may be achieved by performing either singular value decomposition of the channel response matrix H or eigenvalue decomposition of the correlation matrix of H. The eigenvalue decomposition of the correlation matrix is:

R=H^{H}H=VΛV^{H},

where Λ is an N_{T}×N_{T} diagonal matrix of eigenvalues of R that represent power gains for the N_{S} eigenmodes of H.

Eigenmode transmission refers to transmission of data on the Ns eigenmodes of the MIMO channel. Eigenmode transmission requires spatial processing by both the transmitter and the receiver. The spatial processing at the transmitter for eigenmode transmission on subband k may be expressed as:

x(k)=V(k)s(k),

where s(k) is an N_{T}×1 data vector with N_{S} non-zero entries for N_{S} modulation symbols to be transmitted on the N_{S} eigenmodes for subband k; and x(k) is an N_{T}×1 transmit vector with N_{T} entries for N_{T} transmit symbols to be sent from the N_{T} transmit antennas for subband k.

The received symbols obtained by the receiver for subband k may be expressed as:

r(k)=H(k)x(k)+n(k)=H(k)V(k)s(k)+n(k),

where r(k) is an N_{R}×1 received vector with N_{R} entries for N_{R} received symbols obtained via the N_{R} receive antennas for subband k; and n(k) is a noise vector for subband k. The spatial processing, or matched filtering, at the receiver to recover the data vector s(k) may be expressed as:

$$\begin{matrix}\hat{s} = {Λ}^{- 1} {V}^{H} {H}^{H} r \\ = {Λ}^{- 1} {V}^{H} {H}^{H} ( HVs + n ) \\ = s + \tilde{n} ,\end{matrix}$$

where ŝ is an N_{T}×1 estimated data vector with up to N_{S} recovered data symbols, V^{H}H^{H} represents a matched filter, Λ⁻¹ is a normalizing factor, and ñ is a vector of post-processed noise.

This indicates that the Ns data symbol streams s(k), distorted only by post-processed channel noise, may be obtained with ideal spatial processing at both the transmitter and the receiver. However, this result assumes that both the transmitter and the receiver have perfect information about the MIMO channel. In a practical system, both the transmitter and the receiver have noisy estimates of the MIMO channel and/or noisy estimates of the eigenvectors and eigenvalues. Thus, in a practical system, the recovered data symbols for each stream will be corrupted by cross-talk from the other streams:

ŝ=s+c+ñ,

where c is a vector of cross-talk terms generated by off-diagonal terms \hat{V}^{H}Ĥ^{H}H\hat{V}, \hat{V} denotes an estimate of V, and Ĥ is an estimate of H.

One aspect of the invention provides for employing an asymptotically optimal decoding algorithm (such as a trellis-exploration algorithm similar to a Viterbi Algorithm) to update the estimated spatial-processing matrix \hat{V}. Branch metrics are calculated based on at least one fitness function for possible state transitions between two successive states. A fitness function may comprise a measure of orthogonality between the spatial subchannels. Path metrics are calculated from the branch metrics for possible paths constituted by successive state transitions and ending in each of the states. For each state, the path having an optimal path-metric value is selected.

A trellis-exploration algorithm may be employed for updating the spatial-processing matrix \hat{V} once the spatial processing matrix has been estimated via some alternative means, such as a singular value decomposition. In one aspect of the invention, a low-complexity method may be employed for generating an initial rough estimate of the spatial-processing matrix \hat{V}, followed by performing updates via asymptotically optimal decoding. In another aspect, asymptotically optimal decoding may be employed for updating the spatial-processing matrix \hat{V} in response to changes in operating parameters that affect spatial processing. For example, updates may be made in response to changing channel conditions, changes in the number of spatial channels to N_{S}, or any other factors that impact correlations between spatial subchannels. In yet another aspect, an asymptotically optimal decoding algorithm may be employed for deriving \hat{V} without first performing a singular value decomposition. In alternative aspects of the invention, the fitness function may comprise multiple objectives for pre-coding selection, including spreading to reduce PAPR.

It should be appreciated that the processors 802.1-802.N shown in FIG. 8, as well as method aspects of the invention, may be implemented using a variety of hardware and software. For example, the processors 802.1-802.N may be implemented using special-purpose hardware, such as an application specific integrated circuit (ASIC) and programmable logic devices such as gate arrays, and/or software or firmware running on a computing device, such as a microprocessor, microcontroller or digital signal processor (DSP). It also will be appreciated that although functions of each processor 802.1-802.N may be integrated in a single device, such as a single ASIC, they may also be distributed among several devices.

Furthermore, those skilled in the art should recognize that the method and apparatus aspects described herein may be implemented in a variety of ways, including implementations in hardware, software, firmware, or various combinations thereof. Examples of such hardware may include ASICs, Field Programmable Gate Arrays, general-purpose processors, DSPs, and/or other circuitry. Software and/or firmware implementations of the invention may be implemented via any combination of programming languages, including Java, C, C++, Matlab™, Verilog, VHDL, and/or processor specific machine and assembly languages.

Computer programs (i.e., software and/or firmware) implementing the method of this invention may be distributed to users on a distribution medium, such as a SIM card, a USB memory interface, or other computer-readable memory adapted for interfacing with a wireless device. Similarly, computer programs may be distributed to users via wired or wireless network interfaces. From there, they will often be copied to a hard disk or a similar intermediate storage medium. When the programs are to be run, they may be loaded either from their distribution medium or their intermediate storage medium into the execution memory of a wireless device, configuring an onboard digital computer system (e.g. a microprocessor) to act in accordance with the method of this invention. All these operations are well known to those skilled in the art of computer systems.

The term “computer-readable medium” encompasses distribution media, intermediate storage media, execution memory of a computer, and any other medium or device capable of storing for later reading by a digital computer system a computer program implementing the method of this invention.

Various digital computer system configurations can be employed to perform the method aspects of this invention, and to the extent that a particular system configuration is capable of performing the method aspects of this invention, it is equivalent to the representative system aspects of the invention disclosed herein, and within the scope of this invention.

Once digital computer systems are programmed to perform particular functions pursuant to instructions from program software that implements the method aspects of this invention, such digital computer systems in effect become special-purpose computers particular to the method aspects of this invention. The techniques necessary for this programming are well known to those skilled in the art of computer systems.

The methods and systems described herein merely illustrate particular aspects of the invention. It should be appreciated that those skilled in the art will be able to devise various arrangements, which, although not explicitly described or shown herein, embody the principles of the invention and are included within its scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the invention. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function, or software in any form, including, therefore, firmware, micro-code or the like, combined with appropriate circuitry for executing that software to perform the function. Aspects of the invention as described herein reside in the fact that the functionalities provided by the various recited means are combined and brought together in the manner which the operational descriptions call for.

1. A method for calculating antenna-array weights in a cooperative antenna array comprising a plurality of wireless devices, the method comprising:
calculating branch metrics based on at least one fitness function for a plurality of possible state transitions between two successive states,
calculating path metrics for a plurality of possible paths constituted by successive state transitions and ending in each of said states, and
selecting at least one path for each of said states having an optimal path-metric value.

2. The method recited in claim 1, further configured for assigning the steps of calculating the branch metrics, calculating the path metrics, and selecting to each of the plurality of wireless devices.

3. The method recited in claim 2, wherein calculating the branch metrics further comprises each of the plurality of wireless devices employing a different fitness function.

4. The method recited in claim 2, wherein selecting comprises each of the plurality of wireless devices employing a different decision rule for selecting the at least one path such that each of the plurality of wireless devices is configurable for following a different path when more than one path has the optimal path-metric value.

5. The method recited in claim 2, wherein at least one of the plurality of wireless devices is configured for performing at least one of a by-element variant topology and a by-subchannel variant topology.

6. The method recited in claim 2, wherein each of the plurality of wireless devices is configured for employing a different subchannel-weight constellation.

7. The method recited in claim 2, wherein at least two of the plurality of wireless devices is configured for performing identical calculations for at least one of the steps of calculating the branch metrics, calculating the path metrics, and selecting.

8. The method recited in claim 2, wherein providing for calculating branch metrics is configured to derive the at least one fitness function as a function of eigenvalues of a channel-correlation matrix.

9. The method recited in claim 2, further comprising providing for redundant data storage and redundant data processing.

10. A digital computer system programmed to execute the method recited in claim 1.

11. An apparatus configured for calculating antenna-array weights of a cooperative antenna array comprising a plurality of wireless devices, comprising:
a branch metrics module configured for computing a branch metric for each of a plurality of antenna-array weight candidates, and
an accumulated metrics module configured to add at least one branch metric to at least one previous path metric and select at least one path based on an optimum path metric.

12. The apparatus recited in claim 12, further comprising a survivor storage and updating module configured to store decisions generated by the accumulated metrics module and to perform trace back.

13. The method recited in claim 12, wherein each of the plurality of wireless devices is configured for performing at least one of a by-element variant topology and a by-subchannel variant topology.

14. A machine-readable medium comprising instructions encoded thereon and executable to:
calculate branch metrics based on at least one fitness function for a plurality of possible state transitions between two successive states,
calculate path metrics for a plurality of possible paths constituted by successive state transitions and ending in each of said states, and
select at least one path having an optimal path-metric value, the at least one path corresponding to optimal weights to be used in an antenna array.

15. A method for calculating antenna-array weights in a cooperative antenna array comprising a plurality of wireless devices, the method comprising:
constructing a trellis for a number K of spatial sub-channels, a number of antenna-array elements N, and a number L of antenna-weighting parameters,
generating a fitness function based on estimated antenna-array weights, and
employing a trellis-exploration algorithm for producing updated antenna-array weights.

16. The method recited in claim 15, further comprising determining whether to repeat the steps of generating and employing.

17. The method recited in claim 15, further configured for assigning the steps of constructing, generating, and employing to each of the wireless devices.

18. The method recited in claim 17, wherein generating the fitness function comprises each of the wireless devices generating a different fitness function.

19. The method recited in claim 17, wherein employing the trellis-exploration algorithm comprises each of the plurality of wireless devices employing a different decision rule for selecting paths through the trellis such that each of the wireless devices is configurable for following a different path when more than one path has an optimal path-metric value.

20. The method recited in claim 17, wherein employing the trellis-exploration algorithm comprises performing metric update and performing traceback.

21. The method recited in claim 17, wherein at least one of the plurality of wireless devices is configured for performing at least one of a by-element variant topology and a by-subchannel variant topology.

22. The method recited in claim 17, wherein each of the wireless devices is configured for employing a different subchannel-weight constellation.

23. The method recited in claim 17, wherein at least two of the wireless devices is configured for performing identical calculations when employing the trellis-exploration algorithm.

24. The method recited in claim 17, further comprising providing for redundant data storage and redundant data processing.

25. A digital computer system programmed to execute the method recited in claim 15.
